(19) United States
(12) Patent Application Publication
(10) Pub. No.: US 2011/0221102 A1
(43) Pub. Date: Sep. 15, 2011

(54) Injection stretch blow-molding process for the preparation of polymer containers

(75) Inventors: Cees Besem, Rijen (NL); Anja Gottschalk, Buedingen (DE); Mike Rogers, Macclesfield (GB)

(73) Assignee: BASELL POLIOLEFINE ITALIA S.R.L., Milano (IT)

(21) Appl. No.: 13/128,769

(22) PCT Filed: Oct. 19, 2009
(86) PCT No.: PCT/EP09/63677

§ 371 Date: May 11, 2011

(30) Foreign Application Priority Data
Nov. 27, 2008 (EP) 08170111.2

(51) Int. Cl. B29C 49/06; B32B 1/08; B65D 90/02; B65D 6/00; B65D 85/00

(52) U.S. Cl. 264/513; 428/36.91; 215/379; 220/660; 206/524.6

(57) ABSTRACT

Injection stretch blow-molding process for preparing polymer containers, comprising the following steps:
1) covering, partially or totally, the outside surface of the core rod of a preform mold with a polymer film;
2) injecting a polymer layer over the covered core rod, thus obtaining a preform comprising an inside polymer film layer and an outside polymer layer;
3) stretch blow-molding the said perform, thus obtaining a container comprising an inside polymer film layer and an outside polymer layer.

This application is the U.S. national phase of International Application PCT/EP2009/063677, filed Oct. 19, 2009, claiming priority to European Application 08170111.2 filed Nov. 27, 2008 and the benefit under 35 U.S.C. 119(e) of U.S. Provisional Application No. 61/209,815, filed Mar. 11, 2009; the disclosures of International Application PCT/EP2009/063677, European Application 08170111.2 and U.S. Provisional Application No. 61/209,815, each as filed, are incorporated herein by reference.

The present invention concerns an injection stretch blow-molding process for the preparation of polymer containers, particularly bottles.

Injection stretch blow-molding processes, both single- and two-stage, generally comprising a step where a polymer preform is prepared by injection, followed by a blowing step, are commonly used in the art for the production of containers made of thermoplastic polymer materials, particularly polyethylene terephthalate (PET). In fact PET proves to be particularly adequate to be used for the above mentioned processes because it allows one to operate in a wide temperature range (window of processability), and to obtain molded products having excellent mechanical properties and high transparency.

However, due to its limited property balance there is a strong need to substitute PET with alternative thermoplastic materials. In particular, the crystalline olefin polymers, such as propylene polymers or copolymers containing minor quantities of α-olefin comonomers (such as ethylene or 1-butene, for example) are known to have excellent mechanical properties, such as thermal resistance, and high transparency. Over the traditional economic cycle there may also be a cost benefit.

Therefore many technical solutions have been proposed in the art to obtain polymer containers, in particular bottles, by subjecting PET or propylene polymers to injection stretch blow-molding.

Generally the said containers are characterized by a multilayer structure, in order to achieve or enhance properties not inherent, at least to the desired degree, in the polymer used for the structural part of the containers like, in particular, the gas-barrier properties.

Such multilayer structure can be for example obtained by co-injecting layers of different polymer materials in the mold used to prepare the containers.

According to U.S. Pat. No. 4,797,244, it is possible to put a preformed liner of opportunely chosen polymer materials inside the mold used to prepare the preform, over the core rod, followed by injecting a layer of polymer material in the same mold over the liner, thus obtaining the multilayer structure.

However this technique requires the addition to the production equipments of a specific section where the liner is prepared, for example by thermoforming a sheet. The liner must be properly thermoformed in order to fit the shape of the core rod.

It has now been found that this kind of process can be advantageously simplified by using, instead of the said liner, polymer films available in the market for packaging use.

Such films can be easily introduced at the beginning of the process by simply putting them (for instance by wrapping) on the core rod used in the injection-molding step to prepare the preform. It has been found that to obtain containers with valuable properties it is not required to prepare a liner having the exact shape of the said core rod. At most a tubular structure, preferably sealed on one end, can be used.

Moreover, the process described in U.S. Pat. No. 4,797,244 is an injection blow-molding process. Differently from injection stretch blow-molding, the injection blow molding process does not substantially allow to stretch the preform in the longitudinal (axial) direction, so that the final thickness of the inside polymer layer made of the said liner cannot be easily controlled and reduced to an extent sufficient to achieve the best balance of properties.

In fact it has been found, particularly when the inside polymer layer comprises propylene polymers, that particularly thin inside layers, containing properly selected materials, like ethylene vinyl alcohol copolymers, are sufficient to achieve the desired properties, like gas barrier properties, and that other important properties, like transparency and mechanical strength, are improved as well when such thin layers are biaxially oriented by stretching both in the longitudinal and lateral (radial) directions.

Thus the present invention provides an injection stretch blow-molding process for preparing polymer containers, comprising the following steps:
1) covering, partially or totally, the outside surface of the core rod of a preform mold with a polymer film;
2) injecting a polymer layer over the covered core rod, thus obtaining a preform comprising an inside polymer film layer and an outside polymer layer;
3) stretch blow-molding the said perform, thus obtaining a container comprising an inside polymer film layer and an outside polymer layer.

The term “film layer” in the description of the preform and container obtained respectively in steps 2) and 3) of the process, is used to indicate that the concerned layer has the typical thickness for a film, namely 120 μm or less. As previously said, due to the stretching effect achieved in step 3) as a consequence of stretch blow-molding, the thickness of the film layer results to be decreased with respect to the starting thickness of the film introduced in process step 1).

Thus the thickness of the film layer in the container produced in process step 3) is generally of less than 120 μm to 30 μm, in particular from 30 to 100 μm. When the inside film layer is obtained from a film comprising two or more layers (hereinafter called sub-layers), it is possible and preferable to stretch it to such an extent as to obtain a thickness for each sub-layer of from 5 to 30 μm. Typical stretching ratios to be used in process step 3) in order to obtain such thickness values are of 1.5 or higher, in particular from 1.5 to 3.5 both longitudinal (axial) and lateral (radial).

The longitudinal stretching ratio is the ratio L₂/L₁ of the axial length L₂ of the blown container to the axial length L₁ of the preform, while the lateral stretching ratio is the ratio RW₂/RW₁ of the radial width (diameter) RW₂ of the blown container to the radial width (diameter) RW₁ of the preform.

When part of the preform is not subjected to stretch blowing, like for threaded portions, the said L₁ and L₂ lengths are generally measured on the stretch blown portion, thus excluding the said part not subjected to stretch blowing, like the threaded portion, for example. The RW₁ and RW₂ width values are generally measured in the zone where the largest extent of lateral stretching is obtained.

Moreover, as previously said, as the inside film layer in the container produced in process step 3) is biaxially stretched, whenever the polymer material present in the said film layer is crystalline, like for propylene polymers, it is also biaxially oriented, with the previously said advantageous effects.

Another valuable advantage of the process of the present invention is that it provides preforms and containers, in particular bottles, wherein the inside film layer is totally in contact with the outside polymer layer and well resistant to delamination.

Moreover, the finished containers display excellent optical properties, in particular a low haze.

It has been found that the lowest haze values are obtained when the preform prepared in process step 2) is cooled, preferably up to room temperature (around 25° C.) and subsequently pre-heated before undergoing step 3).

Preferably, the process step 1) is carried out when core rod is located inside the injection mold.

The polymer material used for the film layer and the outside polymer layer can be selected among any thermoplastic polymer and polymer composition suited for use in an injection stretch blow-molding process and, in the case of the film layer, capable contributing the desired properties, liker barrier properties. In particular it is possible to use, for such layers, polyethylene terephthalate (PET) or polyolefins, preferably propylene or ethylene polymers or copolymers or compositions of the same, as previously mentioned.

Among the said propylene polymers or copolymers, preferred are propylene copolymers containing one or more comonomers selected from ethylene and C₄-C₁₀ α-olefins, represented by the formula CH₂═CHR, wherein R is an alkyl radical, linear or branched, with 2-8 carbon atoms or an aryl (in particular phenyl) radical.

Examples of said C₄-C₁₀ α-olefins are 1-butene, 1-pentene, 1-hexene, 4-methyl-1-pentene and 1-octene. Particularly preferred are ethylene and 1-butene.

Preferred features for the said propylene polymers or copolymers are:
isotacticity index: equal to or higher than 80%,
amount of comomomer(s) in the copolymers equal to or lower than 22% by weight, more preferably equal to or lower than 8% by weight, the lower limit being in particular of 0.3% by weight;
MFR L (Melt Flow Rate according to ASTM D 1238, condition L, i.e. 230° C. and 2.16 kg load) from 0.5 to 50, more preferably from 1 to 40 g/10 min.;
Polydispersity Index (PI): from 3 to 6, more preferably from 3 to 5;
a Flexural Modulus of 500 MPa or higher, more preferably of 900 MPa or higher, most preferably of 1400 MPa or higher;
fraction extractable in hexane (FDA 177, 1520): less than 5%, more preferably less than 3% by weight;
fraction soluble in xylene at room temperature: less than 25%, more preferably less than 10%.

Preferred kinds of copolymers are random copolymers containing such an amount of comonomer(s) as to have a melting temperature (measured by DSC) of 130° C. or higher, more preferably of 140° C. or higher. When only ethylene is present as the comonomer, it is generally within 0.8 and 6% by weight with respect to the weight of the polymer. When C₄-C₁₀ α-olefins are present, they are generally within 1 and 10% by weight with respect to the weight of the polymer.

Propylene polymer compositions particularly suited for the preparation of injection stretch blow-molded containers comprise:
a^{I}) 25 wt % to 75 wt %, preferably 35 wt % to 65 wt % of a homopolymer or random copolymer of propylene containing up to 2.0 wt % of at least one comonomer selected from ethylene and C₄-C₁₀ α-olefins, preferably having an isotactic index greater than 80%, more preferably from 90% to 99.5%; and
a^{II}) 25 wt % to 75%, preferably 35 wt % to 65 wt % of a random copolymer of propylene and at least one comonomer selected from ethylene and C₄-C₁₀ α-olefins, containing 0.3 to 30 wt % of said olefin, preferably 0.3 to 20 wt %, more preferably 0.3 to 6%, the comonomer content being different from the comonomer content of the random copolymer a^{I}), preferably at least 1 wt % greater than the comonomer content of the random copolymer a^{I}), and preferably having an isotactic index greater than 60%, more preferably greater than 70%, most preferably equal to or greater than 80%;
   wherein the overall propylene polymer composition preferably has a MFR of 1 to 50 g/10 min., more preferably from 2 to 40 g/10 min.

The expression “wt %” means percent by weight.

The said propylene (co)polymers belong to the family of the (co)polymers that can be obtained by way of polymerization processes in the presence of coordination catalysts. Said processes and the (co)polymers obtained from them are widely described in the art. In particular it is possible to carry out the polymerization process in the presence of a Ziegler-Natta catalyst.

As is well known, the Ziegler-Natta polymerization catalysts comprise the reaction product of an organic compound of a metal of Groups I-III of the Periodic Table (for example, an aluminum alkyl), and an inorganic compound of a transition metal of Groups IV-VIII of the Periodic Table (for example, a titanium halide), preferably supported on a Mg halide. The polymerization conditions to be used with such catalysts generally are well known also.

For example one can use the high yield and highly stereospecific Ziegler-Natta catalysts and the polymerization processes described in U.S. Pat. No. 4,399,054, EP-A-45977, EP-A-361493 and EP-A-728769, WO0063261, WO0230998, WO02057342 and WO02051912. Other suitable coordination catalysts that can be used in polymerization to prepare the said propylene (co)polymers are the metallocene catalysts.

The said polymerization catalysts comprise the reaction product of a metallocene and a compound such as an alumoxane, trialkyl aluminum or an ionic activator. A metallocene is a compound with at least one cyclopentadienyl moiety in combination with a transition metal of Groups IV-VIII of the Periodic Table.

For example one can use the metallocene catalysts described in WO 01/48034 and WO 03/045964.

When the polymer material is a propylene polymer composition, such polymer material can be prepared by polymerizing the monomers in two or more consecutive or parallel stages. The polymerization can be carried out in any known manner in bulk, in suspension, in the gas phase or in a supercritical medium. It can be carried out batchwise or preferably continuously. Solution processes, suspension processes, stirred gas-phase processes or gas-phase fluidized-bed processes are possible. As solvents or suspension media, it is possible to use inert hydrocarbons, for example isobutane, or the monomers themselves.

The above mentioned MFR values can be obtained directly in polymerization by adequately adjusting the molecular weight regulating agent (such as hydrogen, for example), or can be achieved by way of a visbreaking process to which the propylene (co)polymers are subjected. The visbreaking process of the polymer chains is carried out by using the appropriate techniques. One of said techniques is based on the use of peroxides which are added to the (co)polymer in a quantity that allows one to obtain the desired degree of visbreaking.

The peroxides that are most conveniently employable for the visbreaking process have a decomposition temperature preferably ranging from 150 to 250° C. Examples of said peroxides are the di-tert-butyl peroxide, the dicumyl peroxide, the 2,5-dimethyl-2,5-di(tert-butyl peroxy)hexyne, and the 2,5-dimethyl-2,5-di(tert-butyl peroxy)hexane, which is marketed under the Luperox 101 trade name.

The quantity of peroxide needed for the visbreaking process preferably ranges from 0.05% to 1% by weight of the (co)polymer.

Among the ethylene polymers or copolymers, preferred are the so called high density polyethylenes (HDPE). Particularly preferred are said ethylene (co)polymer having density equal to or greater than 0.945 g/cm³, in particular from 0.945 g/cm³ to 0.960 g/cm³ (measured according to ISO 1183) and F/E ratio values equal to or greater than 60, in particular from 60 to 100 (measured according to ISO 1133).

The ethylene copolymers typically contain C₄-C₁₀ α-olefins, preferably in amounts up to 10% by weight, like in particular 1-butene, 1-pentene, 1-hexene, 4-methyl-1-pentene and 1-octene, and their mixtures.

The F/E ratio is the ratio between the Melt Flow Rate measured at 190° C. with a load of 21.6 kg (also called condition F) and the Melt Flow Rate measured at 190° C. with a load of 2.16 kg (also called condition E).

Other additives used in the said (co)polymers can include, but are not limited to phenolic antioxidants, phosphite-series additives, anti-static agents and acid scavengers, such as sodium stearate, calcium stearate and hydrotalcite.

The polymer film introduced in process step 1) to obtain the inside polymer layer is preferably a multilayer film comprising two or more sub-layers, as previously mentioned.

Preferably it comprises at least one sub-layer having gas-barrier properties.

In particular, the said film can have a A/C/A or a A/B/C/B/A structure, wherein the sub-layer C is the layer composed of or comprising a polymer material having the desired additional properties, in particular gas-barrier properties, the sub-layers B are the so called “tie layers”, used to enhance adhesion with the outside layers, and the sub-layers A are the outside layers. The said polymer materials with gas-barrier properties that can be present in sub-layer C, are well known in the art. In particular, they can be selected from EVOH, Polyamides, such as nylon 6, MXD-6, PET, PGA (polyglycolic acid), PEN (polyethylene naphthalate), PVA (polyvinyl acetate), PVOH (polyvinyl alcohol) and pigmented combinations to give visible light or UV barrier.

The tie sub-layers generally comprise a thermoplastic polymer material of the same kind as the material used for the outside sub-layers, blended with an adhesive material, which is generally present in amounts of 50% by weight or less with respect to the total weight of the polymer material.

When the outside sub-layers comprise olefin polymers, the most preferred adhesive materials are modified olefin polymers, in particular propylene or ethylene homopolymers and copolymers.

In terms of structure, the modified olefin polymers are preferably selected from graft or block copolymers.

In this context, preference is given to modified polymers containing groups deriving from polar compounds, in particular selected from acid anhydrides, carboxylic acids, carboxylic acid derivatives, primary and secondary amines, hydroxyl compounds, oxazoline and epoxides, and also ionic compounds.

Specific examples of the said polar compounds are unsaturated cyclic anhydrides and their aliphatic diesters, and the diacid derivatives. In particular, one can use maleic anhydride and compounds selected from C₁-C₁₀ linear and branched dialkyl maleates, C₁-C₁₀ linear and branched dialkyl fumarates, itaconic anhydride, C₁-C₁₀ linear and branched itaconic acid dialkyl esters, maleic acid, fumaric acid, itaconic acid and mixtures thereof.

Particular preference is given to using a propylene polymer grafted with maleic anhydride as the modified polymer.

The modified olefin polymers can be produced in a simple manner by reactive extrusion of the polymer, for example with maleic anhydride in the presence of free radical generators (like organic peroxides), as disclosed for instance in EP0572028.

Preferred amounts of groups deriving from polar compounds in the modified polymers are from 0.5 to 3% by weight.

The outside sub-layers are generally made of the same kind of polymer materials as the polymer materials used for the outside layers of the prefoms and containers.

The said films are produced by using processes well known in the art.

In particular, extrusion processes can be used.

In said extrusion processes the polymer materials to be used for the various layers are molten in different extruders and extruded through a narrow die slit. Subsequent from the exit from the die, the material can be cooled, heated and oriented in several ways.

Specific examples of extrusion processes are the cast film, blown film and BOPP processes. All the steps of the process of the present invention can be carried out in conventional injection stretch blow-molding equipments.

In process step 1), the outside surface of a core rod of an injection-molding apparatus is covered, partially or totally, with the previously described polymer film.

It is possible to wrap the polymer film (in form of a planar film) around the said core rod or to shape it in advance in a cylindrical tubular structure, by cutting a portion of the film and sealing its edges to form a film tube with openings at the two ends. It is also possible to produce the film tube directly by (co)extrusion of a layflat tube to give the correct diameter for the preform core rod. Preferably one of the two ends is sealed, thus obtaining a film tube having an open end and a closed end. The said closed end can be obtained by sealing the two sides together using a shaped welding horn, or sealing it to a disk or cap, preferably obtained from the same film.

The core rod is then covered with the said film tube.

By selection of the length of the cut film tube, preforms can be produced either with barrier film going into the top providing the maximum barrier property to the container. Alternatively, with a shorter cut film tube, the threaded part of the preform can be left with no interior film, which gives the benefit of easier separation of the film for recycling purposes. The temperature and pressure at which the polymer material is injected in process step 2) to obtain the outside polymer layer of the preform should be selected by those skilled in the art depending on the particular polymer composition involved. For propylene polymers or copolymers, the injection temperature is preferably from 200 to 280° C., and the injection pressure is 25-50 MPA (250-500 bar). The mold used in process step 2) can be any conventional mold used to make preforms in injection stretch blow-molding equipments. Again, the blow-molding temperature in process step 3) should be selected by those skilled in the art depending on the polymer composition being molded.

For propylene polymers or copolymers, the blow-molding temperature is preferably from 100 to 160° C.

All steps 1) to 3) in the process can be performed in the same machine, in the so-called single-stage process. In such a case it is operated without cooling the preform to room temperature. Alternately, and preferably, steps 1) and 2) may be carried out in a first piece of equipment (first process stage), and subsequently, in a second process stage, the obtained preforms are routed to a second piece of equipment for stretch blow-molding 3), in the so called two-stage process. In such a case, the preforms can be allowed to cool to room temperature (about 25° C.) before stretch blow-molding.

Typically the stretch-blow molding temperature for a single-stage process is from 115 to 150° C.

For the two-stage process the preforms are re-heated also to a typical temperature from 115 to 150° C.

Infrared heating units are typically used, but one skilled in the art would recognize that any heat source consistent with the properties of the polymer composition may be used. The preforms are typically conveyed along a bank of heating units while being rotated to evenly distribute the heat. The preforms may also be contacted with cooling air during and after heating to minimize overheating of the preform surface. Once the pre-heated preforms exit the heating oven, the preforms are transferred to a blow mold.

Generally, to carry out process step 3), a stretch rod is inserted into the preform to stretch and guide the preform centrally in the axial direction. Pressurized gas (preferably air) at 0.1 to 4 MPa (1 to 40 bar), preferably 0.4 to 2 MPa (4 to 20 bar) is introduced to complete the blow molding of the finished container or bottle. Optionally, the pressurized gas can be introduced in two steps, where a pre-blow is performed by introducing pressurized gas at 0.1 to 2 MPa (1 to 20 bar), preferably 0.4 to 1.5 MPa (4 to 15 bar), followed by the final blow-molding at the higher pressures described above.

As previously said, the process of the present invention allows one to obtain polymer containers having high physical-mechanical properties.

The following examples, relating to the preparation of stretch-blow molded bottles, are given for illustrating but not limiting purposes.

The following materials are used for the outside polymer layer.
PP1: propylene/ethylene copolymer, containing 3% by weight of ethylene and having Melt Flow Rate of 10 g/10 min. (ASTM D 1238, 230° C., 2.16 kg);
PP2: propylene polymer composition, containing 50 wt % of a propylene random copolymer a^{I}) having an ethylene content of 1 wt %, and 50 wt % of a propylene random copolymer a^{II}) having an ethylene content of 2.3 wt %. The total composition has Melt Flow Rate of 12 g/10 min. (ASTM D 1238, 230° C., 2.16 kg). Such composition was prepared by first prepolymerizing with propylene a high-yield, high-stereospecificity Ziegler Natta catalyst supported on magnesium dichloride. The pre-polymerized catalyst and propylene were then continuously fed into a first loop reactor. The homopolymer formed in the first loop reactor and ethylene were fed to a second loop reactor. The temperature of both loop reactors was 72° C. The polymer was discharged from the second reactor, separated from the unreacted monomers and dried.

The films used for the inside polymer film layer are 5-layer co-extruded layflat tubular films having a A/B/C/B/A structure, with total thickness of 70 and 90 μm and film width (collapsed) of 38 mm.

The thickness of each layer (sub-layer) is reported in Table 1.

TABLE 1

Total thickness
(μm)

| | 70 μm | 90 μm |
|---|---|---|
| A (μm) | 19 | 25 |
| B (μm) | 11 | 10 |
| C (μm) | 11 | 20 |

Such layers are made of the following materials:
layers A: propylene/ethylene copolymer, containing 5% by weight of ethylene and having Melt Flow Rate of 2 g/10 min. (ASTM D 1238, 230° C., 2.16 kg);
layers B (tie layers): anhydride modified polypropylene having density of 0.892 g/cc (ASTM D 2505) and Melt Flow Rate of 4 g/10 min. (ASTM D 1238, 230° C., 2.16 kg), sold by Equistar with trademark Plexar PX 6006;
layer C: Ethylene Vinyl Alcohol copolymer (EVOH), having a Melt Flow Rate of 3.5 g/10 min. (ISO1130, 230° C., 2.16 kg), sold by Nippon Gosei with trademark Soarnol SG654B.

The layflat tubular films are cut in segments and sealed on one end.

The length of said tubular film segments is sufficient to cover entirely the inside surface of the bottles finally obtained.

Using the said materials, four types of preforms and bottles are prepared, as reported in Table 2, where the films used for the inside polymer film layer (identified with the total film thickness) and the polymer materials used for the outside polymer layer are specified.

TABLE 2

| Prefrom/Bottle type | Total film thickness (μm) | Outside polymer layer |
|---|---|---|
| 1 | 70 | PP1 |
| 2 | 90 | PP2 |
| 3 | 70 | PP1 |
| 4 | 90 | PP2 |

The three process steps are carried out under the following conditions.

### Step 1

A preform mold for a 1000 ml water bottle with a single cavity is installed into an injection molding machine.

The core rod of the preform mould is totally covered with one of the previously described tubular film segments.

### Step 2

The mould is closed and preforms are obtained by injecting PP1 or PP2 over the previously described tubular film segment placed on the core rod.

The melt temperature used for the injection is 245° C., the first injection pressure of 45 MPa (450 bar) and second injection pressure of 30 MPa (300 bar). A lower injection pressure is initially used, to avoid deformation and/or displacement of the film. After a first layer of polymer is on the film, injection with full pressure is possible without damaging the film.

The so obtained preforms consist of an inside polymer film layer made of one of the said 5-layer films with substantially unchanged thickness, and an outside polymer layer made of PP1 or PP2, having a thickness of 3 mm and a height of 128 mm

### Step 3

The preforms as described above are re-heated with infrared lamps up to a temperature of 118-138° C. and blown on a single cavity Side1 2-step stretch blow molding machine to produce 1000 ml bottles, operating under the following conditions.

A blowing nozzle is inserted into the preform, guiding the stretching rod, which stretches the preform in the axial direction. There is a pre-blow pressure of 0.75-1 MPa (7.5-10 bar) to avoid a contact between the preform and the stretching rod during the axial stretching and to start the radial stretching. This is followed by high pressure blowing at 1.2-1.4 MPa (12-14 bar) to finish the blowing into the bottle mold.

The longitudinal (axial) stretching ratio is of 2.1, measured on the stretch blown portion, while the lateral (radial) stretching ratio is of 2.2, measured in the zone where the largest extent of lateral stretching is obtained, resulting into the largest width.

The height of the bottles is of 251 mm, and the half developed length (outside length from under the thread to the injection point on the bottom) is of 280 mm.

The bottles are easily blown for the four different preform types and are transparent. They are blown with good wall-thickness distribution (in particular, the final thickness of sub-layer C is of about 12 μm) and the film stays in position without delaminating on blowing.

The wall thickness of the bottles is of about 0.4 mm.

1. An injection stretch blow-molding process for preparing polymer containers, comprising the following steps:
1) covering, partially or totally, the outside surface of a core rod of a preform mold with a polymer film, thereby forming a covered core rod;
2) injecting a polymer layer over the covered core rod, thus obtaining a preform comprising an inside polymer film layer and an outside polymer layer;
3) stretch blow-molding the preform, thus obtaining a container comprising an inside polymer film layer and an outside polymer layer.

2. The process of claim 1, wherein the polymer film used in step 1) is in the form of a tubular film.

3. The process of claim 1, wherein the preform obtained in step 2) is cooled and subsequently pre-heated before undergoing step 3).

4. The process of claim 1, wherein step 3) is carried out with a stretching ratio of at least 1.5, both longitudinal and lateral.

5. The process of claim 1, wherein the film is a multilayer film containing at least two sub-layers and at least one sub-layer of such film has gas-barrier properties.

6. A preform obtained by a process comprising:
1) covering, partially or totally, the outside surface of a core rod of a preform mold with a polymer film, thereby forming a covered core rod;
2) injecting a polymer layer over the covered core rod, thus obtaining a preform comprising an inside polymer film layer and an outside polymer layer.

7. A container obtained by the process of claim 1.

8. The container of claim 7, wherein the container is in the form of a bottle.

9. The preform of claim 6, wherein both the inside polymer layer and outside polymer layer comprise a propylene polymer or copolymer.

10. The preform of claim 6, wherein the inside film layer has two outside sub-layers comprising a propylene polymer or copolymer and a core sub-layer comprising a polymer material with gas-barrier properties.

11. The container of claim 7, wherein both the inside polymer layer and outside polymer layer comprise a propylene polymer or copolymer.

12. The container of claim 7, wherein the inside film layer has two outside sub-layers comprising a propylene polymer or copolymer and a core sub-layer comprising a polymer material with gas-barrier properties.
